(19) United States
(12) Patent Application Publication
(10) Pub. No.: US 2010/0061232 A1
(43) Pub. Date: Mar. 11, 2010

(54) LOAD BALANCING MECHANISM FOR DYNAMIC SERVING FUNCTIONAL ELEMENTS SELECTION

(76) Inventors: Wei Hua Zhou, Beijing (CN); Yi Zhang, Beijing (CN); Shun Liang Zhang, Beijing (CN); Alexander Bachmutsky, Sunnyvale, CA (US)

Correspondence Address: BRAKE HUGHES BELLERMANN LLP, c/o CPA Global, P.O. BOX 52050, MINNEAPOLIS, MN, 55402, US

(21) Appl. No.: 12/205,684

(22) Filed: Sep. 5, 2008

(51) Int. Cl. H04W 28/08

(52) U.S. Cl. 370/230

(57) ABSTRACT

A method of using a base station comprising establishing a connection with a plurality of authenticators. In one embodiment, the method further including receiving, from each authenticator, load balancing parameters indicating the state of the respective authenticator. In various embodiments, the method may also include receiving, from a mobile station, a request to join a network including the base station. In some embodiments, the method may include selecting an authenticator, to authenticate the mobile station, based upon the load balancing parameters. In one embodiment, the method may include requesting mobile station authentication from the selected authenticator.

### TECHNICAL FIELD

This description relates to communications, and more specifically to the load balancing of devices within a communications network.

### BACKGROUND

The description below and accompanying illustrative figures involve load balancing. In this context, load balancing is generally technique or scheme to spread work between two or more computers or processing engines. In various embodiments, the processing engines may be executed by a computing system. Often load balancing involves a network of computing devices or systems. In various embodiments, various networking standards may be used. It is contemplated that the disclosed subject matter includes a generic technique and devices for any interface, any type of network (e.g., Long Term Evolution (LTE), System Architecture Evolution (SAE), etc.) in which dynamic load balancing application is desired. However, for illustrative purposes the terminology of Worldwide Interoperability for Microwave Access (WiMAX) is a telecommunications technology is generally used throughout the document and figured; although, it is understood that WiMAX is merely an illustrative example to which the disclosed subject matter is not limited.

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

One particular derivative of the 802.16 standard is the, as yet finished, 802.16m standard that attempts to increase the data rate of wireless transmissions to 1 Gbps while maintaining backwards compatibility with older networks. IEEE 802.16 Broadband Wireless Access Working Group, IEEE 802.16m System Requirements, Oct. 19, 2007.

### SUMMARY

According to one general aspect, a method of using a base station comprising establishing a connection with a plurality of authenticators is shown. In one embodiment, the method further including receiving directly or indirectly, from each authenticator, load balancing parameters indicating the state of the respective authenticator. In various embodiments, the method may also include receiving, from a mobile station, a request to join a network including the base station. In some embodiments, the method may include selecting an authenticator, to authenticate the mobile station, based upon the load balancing parameters. In one embodiment, the method may include requesting mobile station authentication from the selected authenticator.

According to another general aspect, an apparatus comprising a transceiver, a controller and a memory is shown. In various embodiments, the transceiver may be configured to receive, from a plurality of authenticators or other network elements or functional entities distributing the information on authenticators' behalf, a set of load balancing parameters indicating the state of the respective authenticator. In some embodiments, the transceiver may also be configured to receive, from a mobile station (MS), a request to use a service provided by the authenticator. In some embodiments, the transceiver may also be configured to forward a service request from the mobile station to a selected authenticator. In one embodiment, the memory may be configured to store a plurality of load balancing parameters received from or on behalf of the plurality of authenticators. In some embodiments, the controller may be configured to select an authenticator from amongst the plurality of authenticators to provide the requested service to the mobile station.

The details of one or more implementations are set forth in the accompanying drawings and the description below. Other features will be apparent from the description and drawings, and from the claims.

A system and/or method for load balancing, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of two example embodiments of apparatuses in accordance with the disclosed subject matter.

FIG. 4 is a block diagram of an example embodiment of a system in accordance with the disclosed subject matter.

FIG. 5 is a flow chart of an example embodiment of a technique in accordance with the disclosed subject matter.

FIG. 6 is a block diagram of an example embodiment of a system in accordance with the disclosed subject matter.

### DETAILED DESCRIPTION

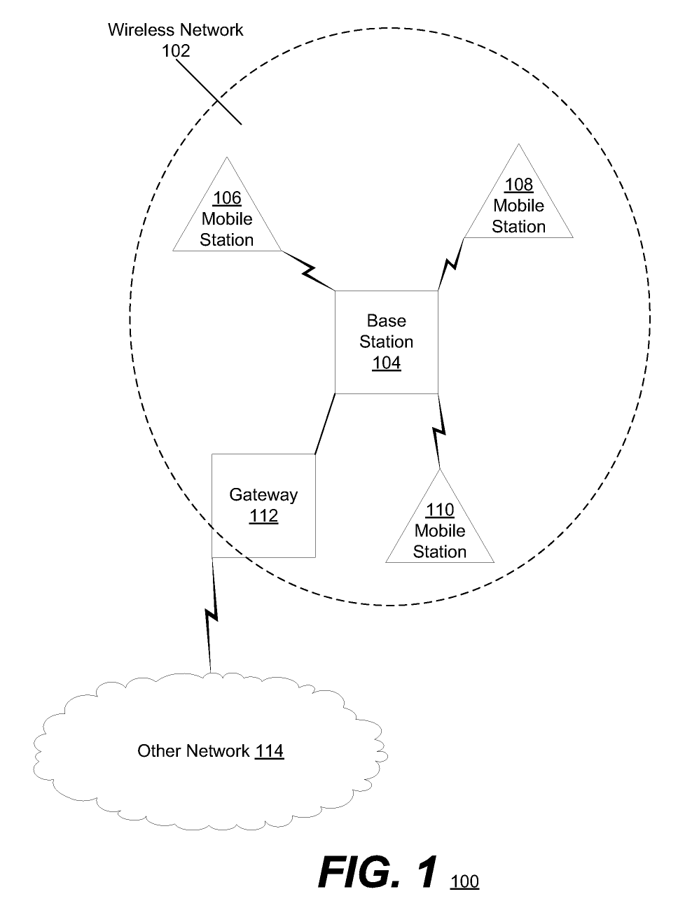

Referring to the Figures in which like numerals indicate like elements, FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network (not shown), such as a Local Area Network, a Wide Area Network (WAN), the Internet, etc. In various embodiments, the base station 104 may be coupled or connected with the other network 114 via an access network (ASN) controller or gateway (GW) 112 that may control, monitor, or limit access to the other network. The text further uses for explanation and figures simplicity the WiMAX name ASN for the access network and the WiMAX name ASN-GW for the access network gateway; although, it is understood that WiMAX is merely one illustrative example networking standard to which the disclosed subject matter is not limited.

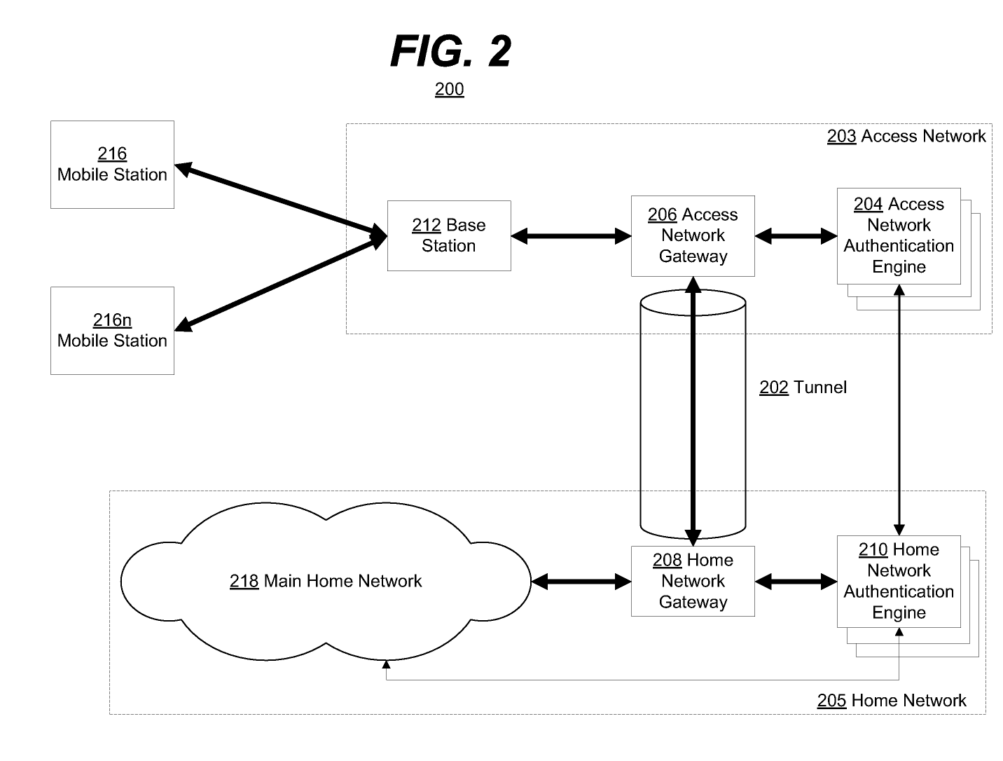

FIG. 2 is a block diagram of an example embodiment of a system 200 in accordance with the disclosed subject matter. In one embodiment, the system 200 may include a plurality of mobile stations (MSs) 216 and 216n, an access network 203, and a home network 205. In various embodiments, the mobile stations 216 and 216n may join or become associated with the access network 203.

In one embodiment, the access network 203 may include a base station (BS) 212, an access network gateway (ASN-GW) 206, and at least one access network authenticator and/or authorization engine (ASN-AE) 204. In various embodiments, the ASN-GW 206 and the BS 212 may be co-located or residing within or as part of a single machine. In various embodiments, the ASN-GW 206 and one or more instances of the ASN-AE 204 may be co-located or residing within or as part of a single machine.

In various embodiments, a MS 216 may wish to join an access network 203 (e.g., a network at a coffee shop, a hotel, etc.). In such an embodiment, the MS 216 may contact the BS 212 and request permission to join the access network 203. In various embodiments, this interaction may occur over a wireless network, as described above. In some embodiments, the BS 212 may communicate with an authenticator, such as, ASN-AE 204, in order to authenticate the MS 216 and receive proof or authorization that the MS 216 may join the network 203 with an access to a subset or all of services offered by the network 203.

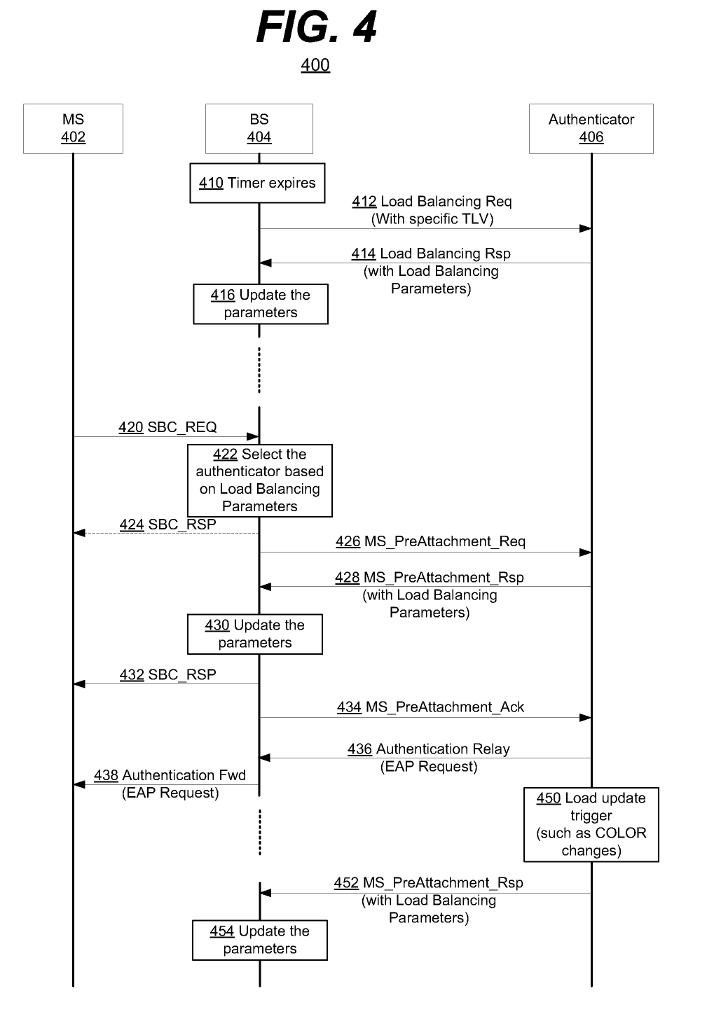

In various embodiments, a plurality of ASN-AEs 204 and ASN-GWs 206 may be used. In such an embodiment, the BS 212 may attempt to decide which ASN-AE 204 to use for authentication purposes. In various embodiments, this decision may be fairly simplistic, for example a BS 212 may be associated with only one ASN-AE 204, and therefore all requests from the BS 212 (either originating at or forwarded by the BS 212) may be sent to that particular ASN-AE 204. In another embodiment, the BS 212 may be associated with a plurality of ASN-AEs 204. In such an embodiment, the decision of which ASN-AE 204 to use for authentication may become more involved, as described below in reference to FIG. 4.

In various embodiments, if the ASN-AE 204 is overloaded or otherwise reduced in functionality (e.g., a disabled network card, etc.), authentication of the MS 216 may be denied or, for example, take an inordinate amount of time. In some embodiments, a failure of the ASN-AE 204 to respond to an authentication request within a certain amount of time may be considered to be a denial of authentication. In various embodiments, if a MS 216 is not authenticated or approved by the ASN-AE 204, the BS 212 may deny the MS 216 entry into the access network 203.

However, in various embodiments, if the MS 216 is properly authenticated and allowed access to the access network 203, the BS 212 may relay messages or communication between the MS 216 and the ASN-GW 206. In some embodiments, the ASN-GW 206 may provide a communications channel between the access network 203 and other networks (e.g., the Internet). In some embodiments, the other networks may include a home network 205 (e.g., a network at the MS owner's work, home, etc.). In one embodiment, a tunnel 202 may be established to allow secure or seamless communication between the MS 216 and the home network 205. In various embodiments, the home network 205 may include a home network gateway (HN-GW) 208, a plurality of home network authentication engines (HN-AE) 210, and a main home network 218. However, it is understood that the above home network 205 merely an illustrative example to which the disclosed subject matter is not limited.

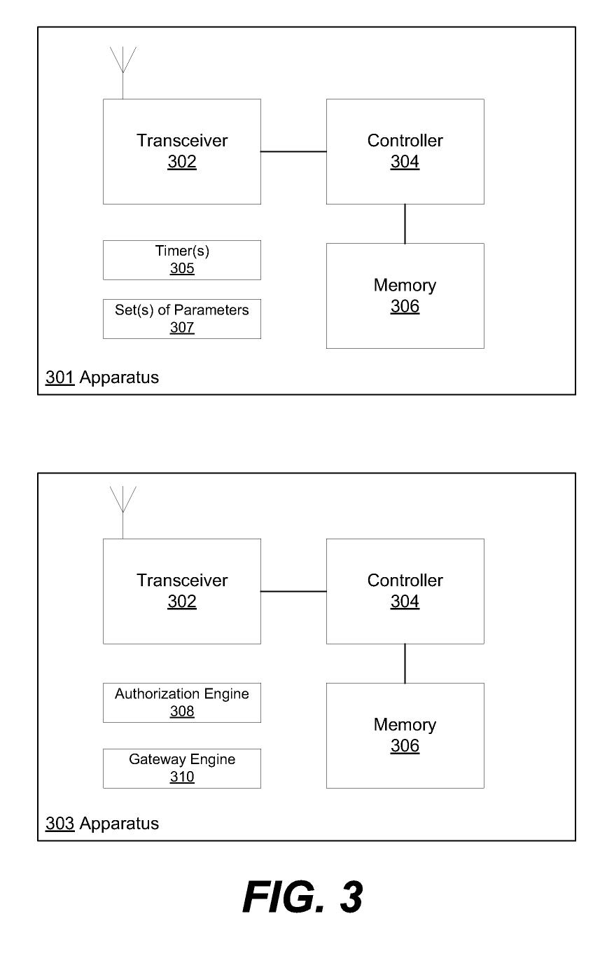

FIG. 3 is a block diagram of two example embodiments of apparatuses 301 and 303 in accordance with the disclosed subject matter. In one embodiment, the communications device 301 may include a base station (BS), gateway (GW), or a mobile station (MS) such as that illustrated in FIGS. 1 and 2. In one embodiment, the communications device 301 may include a transceiver 302, a controller 304, and a memory 306. In some embodiments, the transceiver 302 may include a wireless transceiver configured to operate based upon a wireless networking standard (e.g., WiMAX, WiFi, WLAN, etc.). In other embodiments, the transceiver 302 may include a wired transceiver configured to operate based upon a wired networking standard (e.g., Ethernet, etc.). In various embodiments, the controller 304 may include a processor. In various embodiments, the memory 306 may include permanent (e.g., compact disc, etc.), semi- permanent (e.g., a hard drive, etc.), and/or temporary (e.g., volatile random access memory, etc.) memory. In one embodiment, the communications device 301 may include at least one timer 305 configured to control the maximum period between the transmittal of messages requesting load balancing parameters from another device (e.g., an authenticator). In various embodiments, the communications device 301 may include a set or sets of parameters or load balancing parameters 307 received from the other device. For example, some operations illustrated and/or described herein, may be performed by a controller 304, under control of software, firmware, or a combination thereof. In another example, some components illustrated and/or described herein, may be stored in memory 306.

FIG. 3 is also a block diagram of a communications device 303 in accordance with an example embodiment of the disclosed subject matter. In one embodiment, the communications device 303 may include a base station (BS), gateway (GW), or an authenticator such as that illustrated in FIG. 1 and/or FIG. 2. In one embodiment, the communications device 303 may include a wireless transceiver 302, a controller 304, and a memory 306. In some embodiments, the transceiver 302 may include a wireless transceiver configured to operate based upon a wireless networking standard (e.g., WiMAX, WiFi, WLAN, etc.). In other embodiments, the transceiver 302 may include a wired transceiver configured to operate based upon a wired networking standard (e.g., Ethernet, etc.). In various embodiments, the controller 304 may include a processor. In various embodiments, the communications device 303 may include an authentication engine 308 configured to process authentication requests received by the communications device 303. In one embodiment, the communications device 303 may include a gateway engine 310 that is configured to facilitate communication between a plurality of networks, as described above. In various embodiments, the communications device 303 may serve as a co-located ASN-GW and BS, as described above. In various embodiments, the communications device 303 may serve as a co-located ASN-GW and ASN-AE, as described above. In some embodiments, the authentication engine 308 and gateway engine 310 may be part of or executed by the controller 304.

FIG. 4 is a block diagram of an example embodiment of a system 400 in accordance with the disclosed subject matter. Similarly to other terms used in this invention, FIG. 4 is also using WiMAX terms for network elements and messages, and it is done only for the purpose of easy demonstration without limiting the wider scope of the invention. In one embodiment, the system 400 may include a mobile station (MS) 402, a base station (BS) 404, and an authenticator 406. In various embodiments, the authenticator 406 may be part of or include an access network authentication engine (e.g., ASN-AE 204 of FIG. 2). In another embodiment, the authenticator 406 may be part of or include an access network gateway (e.g., ASN-GW 206 of FIG. 2) and/or BS 404. In various embodiments, the system 400 may include a plurality of authenticators of which only one is shown.

In one embodiment, the BS 404 may be established on a network that includes at least one authenticator 406. In such an embodiment, the BS 404 may receive or be assigned information including for example a network address, default routing information, a default or fail-safe choice to use as an authenticator 406, etc. In such an embodiment, the BS 404 may establish a connection with a plurality of authenticators 406. In various embodiments, establishing a connection with the authenticators 406 may include broadcasting a message asking for each authenticator 406 to identify itself to the BS 404; although, it is understood that the above is merely one illustrative example to which the disclosed subject matter is not limited.

In one embodiment, the BS 404 may be configured to dynamically select which of the plurality of authenticators 406 to use when performing authentication tasks or operations. In such an embodiment, the BS 404 may collect or maintain a set of parameters about each authenticator 406. In various embodiments, these parameters may be stored within a memory (e.g., memory 306 of FIG. 3).

In various embodiments, the BS 404 may define and/or maintain a timer (e.g., timer 305 of FIG. 3) for each associated authenticator 406. In some embodiments, each timer may include a separate amount of time (or other unit of measurement) for each authenticator 406 based upon a value received by the authenticator 406 or other device. In another embodiment, a default amount of time (or other unit of measurement) may be predefined.

Block 410 illustrates that, in one embodiment, the timer for a particular authenticator 406 may expire. In various embodiments, a central or group timer may be used, as opposed to a plurality of individual timers each associated with a respective authenticator 406. In one embodiment, a timer may be used for each BS 404/Authenticator 406 pair. In such an embodiment, the period between timer expirations may be relatively long (e.g., a period measured in minutes). In such an embodiment, the BS 404 may be configured to reset the timer once the set of load balancing parameters has been updated. In other embodiments, other techniques (e.g., dynamically adaptive techniques, authenticator response time, network conditions, etc.) for determining when to request information regarding the authenticators 406 may be used; although, it is understood that the above are merely a few illustrative examples to which the disclosed subject matter is not limited.

In one embodiment, message 412 may be transmitted to all authenticators 406 or, in one embodiment, just the authenticator 406 associated with the expired timer. In various embodiments, the message 412 may include a specific load balancing request or a request for information regarding the state of the authenticator 406.

In other embodiments, the message 412 may be included as part of the next scheduled or normally occurring message (e.g., a MS Pre-Attachment request, etc.) to the authenticator 406. In such an embodiment, the timer may include two or more expiration points. A first expiration point may indicate that the BS 404 should include the message 412 as part of the next normally occurring message to the authenticator 406, and a second expiration point at which time, if the message 412, has not yet been transmitted, the BS 404 should transmit a specific message conveying a request for information regarding the state of the authenticator 406.

In one embodiment, in which the authenticator 406 and a gateway are co-located, the BS 404 may place the message 412 within or as part of a message to the gateway. In various embodiments, the message 412 may include a specific message parameter, such as, for example, a type-length-value (TLV) parameter or element. In such an embodiment, the message 412 may be included as part of another message, as described above. In one embodiment, the message 412 can be marked as MS-independent. In various embodiments, the networking standard may expressly forbid a certain MS Identification (MSID) from being assigned to a MS 402 (e.g., zero). In such an embodiment, the MSID parameter may be set to “zero” and used as a “mule” or courier, not of valid MSID information, but of a request for an update of the set of load balancing parameters from the authenticator 406.

In one embodiment, the authenticator 406 may receive the message 412. In various embodiments, in response, the authenticator 406 may transmit a message 414 that includes a set of parameters indicating the state of the authenticator 406. As described above, in various embodiments, this load balancing response or message 414 may be included as a separate message or as part of a normally occurring message. In a specific embodiment, the message 414 may be included as a part of as part of an otherwise non-load balancing message (e.g., an authentication response, a data forwarding message, etc.), as described above. In such an embodiment, the set of parameters may be included as one or more TLV parameters or elements, as described above. In some embodiments, the response to a separate load balancing message 412 may also include a separate message 414, and, in one embodiment, the response to a load balancing request piggybacking on to another normally occurring message may correspondingly use the piggybacking on to another normally occurring response.

In one embodiment, these set of parameters may include load component and a general health component. However, in other embodiments, the set of parameters may simply include only a single component (e.g., a load value, a general health value, etc.).

In various embodiments, the load component may be configured to indicate the amount of capability currently in use or available by the authenticator 406. In various embodiments, this load component may be a measure of work the authenticator 406 is doing. In such an embodiment, the load may be an instantaneous load or, in one embodiment, a time-based averaging of the amount of work performed by the authenticator 406. In such an embodiment, the load may be expressed as a percentage or a raw value of a given unit of measurement. In various embodiments, the load component may be a function of one or more capabilities, such as, processing power, network throughput, input/output (I/O) usage, memory usage, etc. or a combination thereof. In some embodiments, the composition and/or formatting of the load component may be predefined. In another embodiment, the composition and/or formatting of the load component may be dynamically defined by the BS 404 during association and establishment, or as part of message 412.

In one embodiment, the load component may include a complex or multi-dimensional value. In various embodiments, the load component may include a control load component (LoadC) and a data load component (LoadD). In one embodiment, the control load component may be configured to indicate the amount of capability currently available for processing control requests (e.g., an authentication request, as described below). In various embodiments, the data load component may be configured to indicate the amount of capability currently available for processing data requests (e.g., forwarding user data communication as a gateway). In an embodiment in which the authenticator 406 and gateway are co-located on a single machine or system, a multi-dimensional load component may provide a more accurate or nuanced view of the system's capabilities. For example, such a system may be lightly loaded with respect to authentication or control tasks, but heavily loaded in regards to data or gateway processing. In such an embodiment, the BS 404 may be capable of computing a loading vector that represents an expectation by the BS 404 of how quickly and efficiently the authenticator 406 of the system may respond or process authentication requests, and later being able to process efficiently also user data.

In one embodiment, the general health component of the set of parameters may be configured to indicate the overall ability of the authenticator 406 to process requests. In various embodiments, the overall ability of the authenticator 406 to process requests may include a value computed by the authenticator 406. In such an embodiment, instead of merely indicating the loading of the authenticator 406, the general health component may take into account other more persistent conditions (e.g., a broken network card, low disk space, security errors, etc.); although, it is understood that the above are merely a few illustrative examples to which the disclosed subject matter is not limited.

In various embodiments, the general health component may include a uni- or one-dimensional value or parameter. In one such embodiment, the one-dimensional parameter may include a plurality of quantized states. In one embodiment, these quantized states may be colloquially referred to as “colors”. In one such embodiment, the general health component may be represented by “green”, “yellow” and “red” states corresponding to “good health”, “warning” or “questionable health”, and “error” or “poor health”; although, it is understood that the above are merely a few illustrative examples to which the disclosed subject matter is not limited.

For example, if an authenticator 406 is experiencing a substantially sub-optimal condition (e.g., a low amount of available disk space, if one of a plurality of network cards is offline, if a fan has stopped functioning, etc.) the authenticator 406 may transition the general health component from a “green” to a “yellow” state. In one embodiment, if the authenticator 406 is experiencing a more severe condition (e.g., a security error, imminent reboot, no spare disk space, missing file, overheating, fatal software module failure, etc.), the authenticator 406 may indicate a “red” general health component of the set of parameters. In one embodiment, the set of parameters may simply include only the general health or other one-dimensional state-based component. Although, it is understood that the above are merely a few illustrative examples to which the disclosed subject matter is not limited.

Block 416 illustrates that, in one embodiment, the BS 404 may receive the message 414 including a set of parameters indicating the state of the authenticator 406. In such an embodiment, the BS 404 may update the parameters associated with the authenticator 406. In various embodiments, the BS 404 may maintain or store a master list of authenticators 406 and the set of parameters associated with each authenticator 406. In various embodiments, the master list may store only the most recent set of parameters. In another embodiment, a history or representation thereof of the set of parameters for each authenticator 406 may be stored. In such an embodiment, the BS 404 may be configured to track the rate of change or change in state, load, or capabilities of the authenticators 406 in addition to the most recently reported state.

In one embodiment, a MS 402 may wish or attempt to join the network comprising the BS 404 and the authenticator 406. In various embodiments, this may occur a period of time after the Block 416 (as illustrated by the dotted line), and a cause and effect relationship should not be inferred between the two actions. In such an embodiment, the MS 402 may transmit a message 420 requesting to join the network including the BS 404. In various embodiments, this message 420 may be received by the BS 404.

In one specific embodiment, the message 420 may include a Station Basic Capability (SBC) Request (REQ) as illustrated by FIG. 4. In various embodiments, a SBC_Req or message with similar functionality may include a request to receive the necessary (and possibly optional) parameters to communicate with the BS 404, such as, connection identifier, physical communication parameters, bandwidth allocation, etc.; although, it is understood that the above are merely a few illustrative examples to which the disclosed subject matter is not limited.

Block 422 illustrates that, in one embodiment, the BS 404 may select an authenticator 406 to use from the plurality of associated authenticators based, at least in part, on the set of parameters for each authenticator. In various embodiments, a variety of techniques may be used by the BS 404 to select the authenticator 406. In one embodiment, the technique described below may be used.

In one embodiment, the BS 404 may select an authenticator 406 from a sub-set of authenticators having the highest available general health state. For example, the BS 404 may conceptually divide the authenticators into groups or sub-sets based upon their respective general health component states (e.g., green, yellow, red, etc.). The BS 404 may then choose or select an authenticator from the highest or best available state. In such an embodiment, the best available state may be “green”, if no “green” authenticators are available from “yellow” authenticators, and so on. It is understood that a variety of numerical or category based states may be used and are within the scope of the disclosed subject matter.

In one embodiment, once the sub-set of authenticators is selected, the BS 404 may select a single authenticator 406 from among the selected sub-set. In various embodiments, the BS 404 may select the authenticator 406 with the lowest or highest load component (depending on how the load component measures capability). In such an embodiment, the BS 404 may create a load vector to use for selection purposes if the load component includes a multi-dimensional value. In various embodiments, this load vector may include applying weights to the various dimensions of the multi-dimensional value. In another embodiment, the BS 404 may select amongst the authenticators in a round robin, or otherwise more traditional fashion. Although, it is understood that the above are merely a few illustrative examples to which the disclosed subject matter is not limited.

In one embodiment, the BS 404 may respond to the initial network joining message 420 with a partial or temporary response message 424. As described above, in one embodiment, the message 424 may include a Station Basic Capability (SBC) Response (RSP) as illustrated by FIG. 4. In various embodiments, the message 424 may simply include an acknowledgement that the network joining message 420 has been received.

In one embodiment, the BS 404 may request authentication of the MS 402 from the selected authenticator 406. In such an embodiment, the BS 404 may transmit or send an authorization request message 426 to the selected authenticator 406. In various embodiments, the authorization request message 426 may be included as part of a MS pre-attachment request message or series of messages as defined in the networking standard employed by the system 400.

In various embodiments, the authorization request message 426 may be used to request an update of the set of load balancing parameters from the authenticator 406. In one embodiment, a predefined specific parameter or TLV may be used to request the updated set of load balancing parameters, as described above. In another embodiment, a specific or encoded value for an otherwise non-load balancing parameter or TLV may be used.

In various embodiments, the Authenticator 406 may respond to the authorization request message 426 with an authorization response message 428. In various embodiments, this message 428 may approve or deny the MS authorization request. In some embodiments, the authorization response message 428 may include or be part of a MS pre-attachment response message. In some embodiments, the authorization response message 428 may include an updated set of parameters. In various embodiments, these parameters may be included as a field/value pair or TLV parameter, as described above. In another embodiment, the authenticator 406 may only update the set of load balancing parameters when solicited as illustrated by message 412, or, in yet another embodiment, in an unsolicited fashion when a trigger occurs, as illustrated by Block 450, as described below.

Block 430 illustrates that, in one embodiment, if the Authenticator 406 chooses to transmit a set of load balancing parameters, these parameters may be received by the BS 404. In such an embodiment, the BS 404 may update its internal representation of these parameters, as described above in reference to Block 416.

In various embodiments, if the MS 402 was authenticated by the Authenticator 406, the network joining process may continue as normally dictated by the relevant networking standard employed by the system 400. In various embodiments, the authenticator 406 may transmit an updated set of load balancing parameters to the BS 404 as part of any normal authentication based messages (e.g., message 436).

In one embodiment, the BS 404 may respond with a network joining response message 432, as described above. In various embodiments, this message 432 may differ from message 424 in that message 432 may include a more complete response. In one embodiment, the BS 404 may transmit an authentication receipt acknowledgement message 434 to the authenticator 406. In various embodiments, the authenticator 406 may respond with an authentication request or relay message 436. In some embodiments, the authentication request or relay message 436 may include an Extensible Authentication Protocol (EAP) request to be forwarded to the MS 402. In one embodiment, the BS 404 may forward the message 436 to the MS 402 as authorization forwarded message 438. In various embodiments, this forwarding may include repackaging the message 436 in a format or networking protocol used between the MS 402 and the BS 404. In various embodiments, the authentication procedure may continue as defined in the networking standard or standards employed by the system 400. It is understood that the above are merely a few illustrative examples to which the disclosed subject matter is not limited.

In various embodiments, the authenticator 406 may be configured to transmit or send the set of load balancing parameters to the BS 404 in an unsolicited fashion, as opposed to the solicited fashion described above and illustrated by message 412. In various embodiments, the condition of an authenticator 406 may change rapidly and dramatically. In some embodiments, the authenticator 406 may be configured to transmit an unsolicited update of the load balancing parameters when a triggering event occurs. In various embodiments, these triggers may be predefined. In another embodiment, these triggers may be dynamically changeable by the BS 404, authenticator 406, or another device (e.g., a network administration server).

In various embodiments, the authenticator 406 may use the changing of the general health component of the set of parameters as a triggering event. In one embodiment, the changing of the general health component from one state to another (e.g., green to yellow) may trigger an update. A specific example may include an update when a network controller card fails; although, it is understood that the above is merely one illustrative example to which the disclosed subject matter is not limited. In such an embodiment, the authenticator 406 may be configured to apply a hysteresis to the trigger in order to prevent an excessive amount of unsolicited updates if the general health component is changing back and forth between two states.

In another embodiment, the authenticator 406 may be configured to maintain or define a timer for each BS 402 which is associated with the authenticator 406. In such an embodiment, the authenticator 406 may transmit an unsolicited updating message to a BS 402 when the respective timer has expired. Such an embodiment, may be the reverse or a backup to the timer described above in reference to Block 410. In yet another embodiment, the authenticator 406 may be configured to use multiple triggers (for example, both timer and color described above) for an unsolicited update.

It is understood that the above are merely a few illustrative examples to which the disclosed subject matter is not limited. Various embodiments may employ or be configured to use other events or occurrences as a trigger for unsolicited load balancing parameter updating.

In various embodiments, the authenticator 406 may maintain a list of all the BSs 404 associated with the authenticator 406. In such an embodiment, the authenticator 406 may be configured to contact some or all of the BSs 406 when a triggering event occurs. In various embodiments, the type of triggering event may determine which BSs 404 are notified.

In various embodiments, once a triggering event 450 has occurred, the authenticator 406 may transmit or send a message 452 including a set of updated load balancing parameters, as described above. In some embodiments, the message 452 may be part of an unsolicited MS pre-attachment response. In another embodiment, the message 452 may be a specific load balancing message, as described above. In yet another embodiment, the message 452 may be included in the next available message to the BS 404, as described above. In such an embodiment, triggering events may be categorized or prioritized to aid in the selection of the proper form of message to use in transmitting the updated parameters. In one such embodiment, a trigger may be categorized as allowing for transmission of message 452 as part of (e.g., a TLV) the next available non-load balancing message to BS 402, but substantially simultaneously initialize a second triggering event that would then mandate a specialized message for message 452. Such an embodiment of cascading triggers may assure that a balance between the immediacy of information transfer and the overhead of the system 400 is maintained or considered.

In various embodiments, the BS 404 may receive the message 452 and update the BS's 404 internal load balancing parameters, as described above.

It is understood that the above BS/Authenticator communications and pairing are merely a few illustrative examples to which the disclosed subject matter is not limited. It is emphasized that even though above illustrated embodiments illustrate the specific load balancing between BSs and authenticators, the disclosed subject matter is not so limited. More specifically, it is contemplated that the disclosed subject matter includes a generic technique and devices for any interface, any type of network (e.g., Long Term Evolution (LTE), System Architecture Evolution (SAE), etc.) in which dynamic load balancing application is desired. In such an embodiment, the BS, above, may be more generally referred to as “load balancers”. The Authenticators, above, may be more generally referred to as “load balanced devices”. The mobile stations, above, may be referred to generally as “accessing devices”.

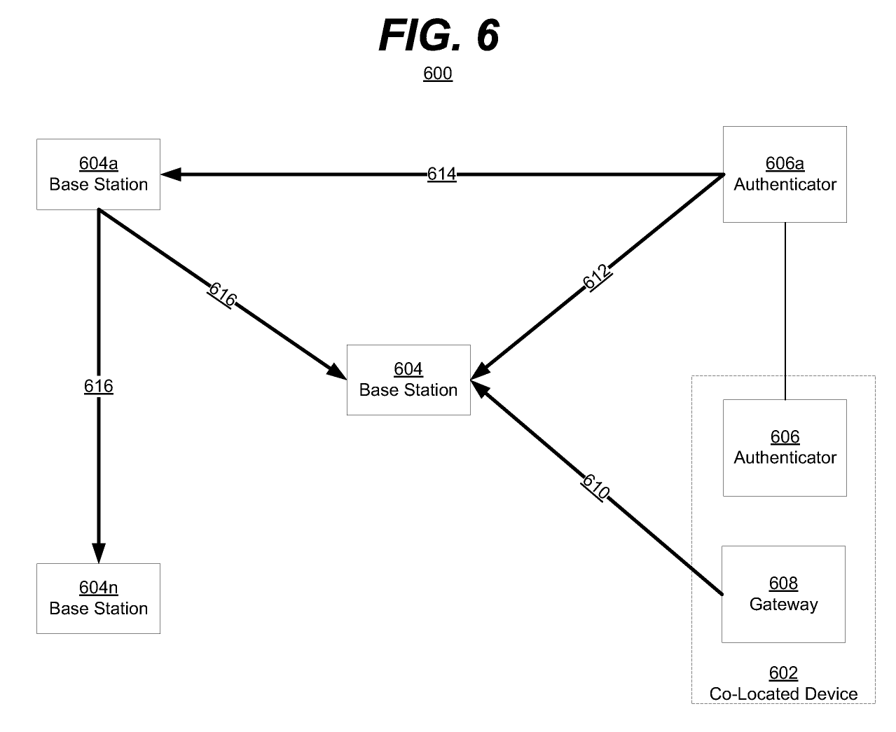

FIG. 6 is a block diagram of an example embodiment of a system 600 in accordance with the disclosed subject matter. In various embodiments, the system 600 may include a plurality of base stations (e.g., base stations 604, 604a, and 604n), a plurality of authenticators (e.g., authenticators 606 and 606a), and a gateway 608. In some embodiments, authenticator 606 and gateway 608 may be co-located as part of co-located device 602.

In various embodiments, authenticator 606 may not be capable of communicating an updated set of load balancing parameters to the base station 604. For example, the authenticator 606 may experience a fatal error, a hardware malfunction of the network card used to communicate with the base station 604, etc. In such an embodiment, the general health component of the authenticator's 606 load balancing parameter may suddenly become “red”. In various embodiments, the base station 604 may be informed of the state of the authenticator 606 via an indirect communication.

In one embodiment, the authenticator 606 and the gateway 602 may be co-located. In such an embodiment, the gateway 602 may notice or be made aware of the state of the authenticator 606. In one embodiment, the gateway 602 may transmit a message 610 to the base station 604 that includes an updated set of load balancing parameters for the authenticator 606. In another embodiment, the gateway 602 may transmit a message 610 to the base station 604 that simply indicates that the authenticator 606 is non-functional or should otherwise be un-associated with the base station 604. In some embodiments, the message 610 may be a special message or a message “piggybacked” onto another message, as described above.

In one embodiment, a second authenticator 606a may notice or be made aware of the state of the authenticator 606. In such an embodiment, the second authenticator 606a may transmit a message 612 to the base station that includes an updated set of load balancing parameters for the authenticator 606. In another embodiment, the second authenticator 606a may transmit a message 612 to the base station 604 that simply indicates that the authenticator 606 is non-functional or should otherwise be un-associated with the base station 604. In some embodiments, the message 612 may be a special message or a message “piggybacked” onto another message, as described above.

In one embodiment, the second authenticator 606a may transmit a message 614, not to the base station 604 but to a second base station 604a. In one such embodiment, the authenticator 606a and the base station 604 may not be associated with each other. Instead, the authenticator 606a may be associated with the second base station 604a. In such an embodiment, the base station 604a may transmit a message 616 to base stations neighboring or within range of the base station 604a (e.g., base stations 604 and 604n). In various embodiments, this message 616 may include the updated load balancing parameters for the authenticator 606. In another embodiment, the message 616 may simply indicate that the authenticator 606 is non-functional or should otherwise be un-associated with the receiving base stations.

It is understood that the above are merely a few illustrative examples to which the disclosed subject matter is not limited. Other various embodiments may exist in which the load balancing parameters or pertinent load balancing information may be indirectly transmitted to a base station (e.g., base station 604).

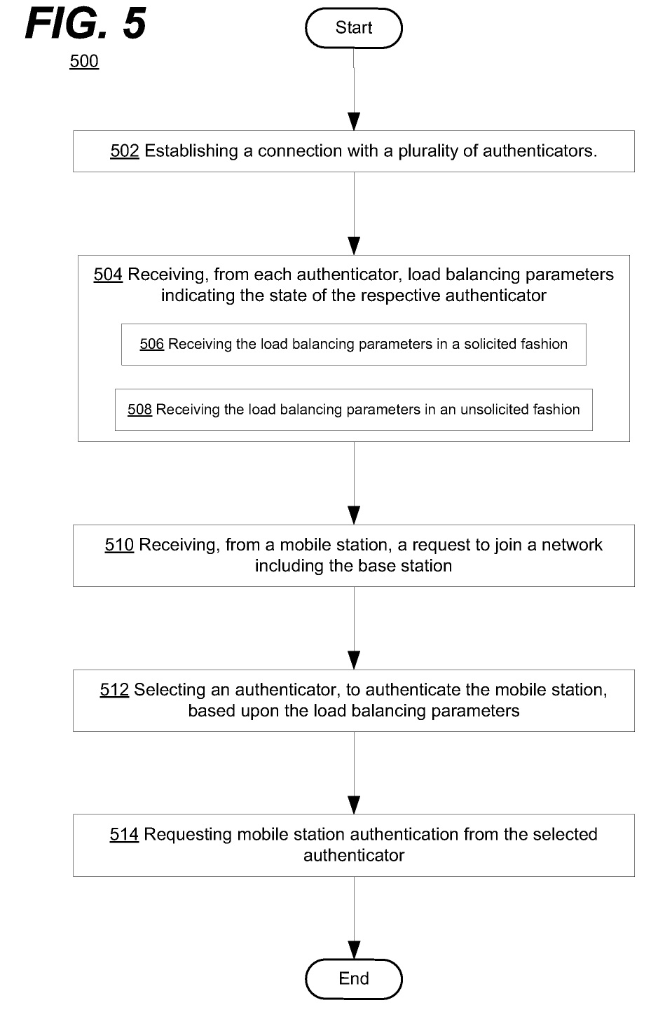

FIG. 5 is a flow chart of an example embodiment of a technique 500 in accordance with the disclosed subject matter. In one embodiment, the technique illustrated by FIG. 5 may be produced by a system or apparatus as shown in FIGS. 1, 2, 3, and 4, as described above.

Block 502 illustrates that, in one embodiment, a connection with a plurality of authenticators may be established, as described above. In various embodiments, establishing may include associating each authenticator with the base station, as described above. In one embodiment, establishing may include establishing a timer on each associated authenticator, as described above. In various embodiments, the actions described above may be performed by base station 212 of FIG. 2 or a transceiver 302 and/or controller 304 of FIG. 3, as described above.

Block 504 illustrates that, in one embodiment, a message may be received, from each authenticator, including load balancing parameters indicating the state of the respective authenticator, as described above. Block 506 illustrates that, in one embodiment, receiving may include receiving the load balancing parameters in a solicited fashion, as described above. In one embodiment, solicited receiving may include transmitting a message to each authenticator requesting information on the state of the authenticators, and receiving, from at least one authenticator, a message including load balancing parameters indicating the state of the respective authenticators, as described above. In another embodiment, solicited receiving may include defining a timer for each of the plurality of authenticators, and when a timer expires, sending to the respective authenticator a request for an updated set of load balancing parameters indicating the state of the authenticator, as described above. In various embodiments, the actions described above may be performed by base station 212 of FIG. 2 or a transceiver 302 and/or controller 304 of FIG. 3, as described above.

Block 508 illustrates that, in one embodiment, receiving may include receiving the load balancing parameters in an unsolicited fashion, as described above. In one embodiment, unsolicited receiving may include receiving an unsolicited message from an authenticator indicating a change in the load balancing parameters, as described above. In various embodiments, unsolicited receiving may include having a timer associated with the base station as part of an authenticator, and when the timer on an authenticator expires, transmitting an unsolicited message to the base station indicating the state of the authenticator, as described above. In some embodiments, receiving may include receiving, as part of an otherwise non-load balancing message, a type-length-value (TLV) element indicating the state of an authenticator, as described above. In various embodiments, the actions described above may be performed by base station 212 of FIG. 2 or a transceiver 302 and/or controller 304 of FIG. 3, as described above.

In one embodiment, the load balancing parameters may includes a load component indicating the amount of work that the authenticator is currently performing; and a general health component indicating the overall ability of the authenticator to process requests, as described above. In various embodiments, the load component may include a control load component indicating the amount of unused capability currently available for processing control requests, and a data load component indicating the amount of unused capability currently available for processing user data, as described above. In some embodiments, the general health component may include a one-dimensional parameter having a plurality of states, as described above. In various embodiments, the parameters described above may be received by base station 212 of FIG. 2 or a transceiver 302 of FIG. 3 and stored by a memory 306 of FIG. 3, as described above.

Block 510 illustrates that, in one embodiment, a message may be received, from a mobile station, which includes a request to join a network including the base station, as described above. In various embodiments, the message described above may be received by base station 212 of FIG. 2 or a transceiver 302 of FIG. 3, as described above.

Block 512 illustrates that, in one embodiment, an authenticator, to authenticate the mobile station, may be selected based upon the load balancing parameters, as described above. In some embodiments, selecting may include selecting an authenticator from a sub-set of authenticators having the highest available general health state, and if the subset of authenticators includes a plurality of authenticators, selecting an individual authenticator from the sub-set of authenticators in a round robin fashion or based on the load information, as described above. In various embodiments, the actions described above may be performed by base station 212 of FIG. 2 or controller 304 of FIG. 3, as described above.

Block 514 illustrates that, in one embodiment, a request for mobile station authentication from the selected authenticator may be transmitted to the selected authenticator, as described above. In one embodiment, this may include forwarding a message from the mobile station, as described above. In another embodiment, this may include receiving a request, reformatting it, and transmitting the request to the selected authenticator, as described above. In various embodiments, the actions described above may be performed by base station 212 of FIG. 2 or a transceiver 302 and/or controller 304 of FIG. 3, as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general, network and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of using a base station comprising:
establishing a connection with a plurality of authenticators;
receiving load balancing parameters indicating the state of at least one of the authenticators;
receiving, from a mobile station, a request to join a network including the base station;
selecting an authenticator, to authenticate the mobile station, based upon the load balancing parameters; and
requesting mobile station authentication from the selected authenticator.

2. The method of claim 1 wherein receiving load balancing parameters includes:
transmitting a message to each authenticator requesting information on the state of the authenticators; and
receiving, from at least one authenticator, a message including load balancing parameters indicating the state of the respective authenticators.

3. The method of claim 1 wherein receiving load balancing parameters includes:
defining a timer for each of the plurality of authenticators; and
when a timer expires, sending to the respective authenticator a request for an updated set of load balancing parameters indicating the state of the authenticator.

4. The method of claim 1 wherein receiving load balancing parameters includes:
receiving an unsolicited message transmitted from an authenticator indicating a change in the load balancing parameters for either the transmitting authenticator or another authenticator.

5. The method of claim 1 wherein the load balancing parameters include:
a load component indicating the amount of work that the authenticator is currently performing; and
a general health component indicating the overall ability of the authenticator to process requests.

6. The method of claim 5 wherein the load component includes:
a control load component indicating the amount of unused capability currently available for processing control requests; and
a data load component indicating the amount of unused capability currently available for processing user data.

7. The method of claim 5 wherein the general health component includes:
a one-dimensional parameter having a plurality of states.

8. The method of claim 1 wherein establishing includes:
associating each authenticator with the base station, and
establishing a timer on each associated authenticator; and
wherein receiving from the authenticators includes:
when the timer on an authenticator expires, transmitting an unsolicited message to the base station indicating the state of the authenticator.

9. The method of claim 1 wherein receiving from the authenticators includes:
receiving, as part of an otherwise non-load balancing message, an information element indicating the state of an authenticator.

10. The method of claim 9 wherein an information element indicating the state of an authenticator is presented in a type-length-value (TLV) form.

11. The method of claim 1 wherein the set of load balancing parameters includes a load component and a general health state component; and
wherein selecting includes:
selecting an authenticator from a sub-set of authenticators having the highest available general health state, and
if the subset of authenticators includes a plurality of authenticators, selecting an individual authenticator from the sub-set of authenticators in a round robin fashion.

12. The method of claim 1 wherein the set of load balancing parameters includes a load component and a general health state component; and
wherein selecting includes:
selecting an authenticator from a sub-set of authenticators having the highest available general health state, and
if the subset of authenticators includes a plurality of authenticators, selecting an individual authenticator from the sub-set of authenticators using the load component.

13. The method of claim 1 further including:
receiving a message indicating the state of an impaired authenticator, wherein the message is transmitted from a device other than the impaired authenticator.

14. A base station (BS) comprising:
a transceiver configured to:
receive, from a plurality of authenticators, a set of load balancing parameters indicating the state of the respective authenticator,
receive, from a mobile station (MS), a request to use a service provided by the authenticator, and
forward a service request from the mobile station to a selected authenticator;
a memory configured to:
store a plurality of load balancing parameters received from the plurality of authenticators; and
a controller configured to:
select an authenticator from amongst the plurality of authenticators to provide the requested service to the mobile station.

15. The base station of claim 14 wherein the transceiver is configured to:
transmit a message to each authenticator requesting a set of load balancing parameters from each authenticators; and
receive, from at least one authenticator, a message including load balancing parameters indicating the state of the respective authenticator.

16. The base station of claim 14 wherein the controller is configured to:
define a timer for each of the plurality of authenticators; and
wherein transceiver is configured to:
when a timer expires, sending to the respective authenticator a request for an updated set of load balancing parameters.

17. The base station of claim 14 wherein transceiver is configured to:
receive an unsolicited message from an authenticator indicating a change in either the authenticator's load balancing parameters or another authenticator's load balancing parameters.

18. The base station of claim 14 wherein the load balancing parameters includes:
a load component indicating the amount of work that the authenticator is currently performing; and
a general health component indicating the overall ability of the authenticator to process requests.

19. The base station of claim 18 wherein the load component includes:
a control load component indicating the amount of unused capability currently available for processing control requests; and
a data load component indicating the amount of unused capability currently available for processing user data.

20. The base station of claim 18 wherein the general health component includes:
a one-dimensional parameter having a plurality of states.

21. The base station of claim 14 wherein the controller is configured to:
associate each authenticator with the base station; and
wherein the transceiver is configured to:
transmit a message requesting that:
a timer be defined on each associated authenticator, and
when the timer expires on a respective authenticator, the authenticator will transmit a load balancing parameters updating message to the base station.

22. The base station of claim 14 wherein the transceiver is configured to:
receive, as part of an otherwise non-load balancing message, an information element including an updated set of load balancing parameters.

23. The method of claim 22 wherein an information element with an updated set of load balancing parameters is presented in a type-length-value (TLV) form.

24. The base station of claim 14 wherein the set of load balancing parameters includes a load component and a general health state component; and
wherein the controller is configured to:
select an authenticator from a sub-set of authenticators having the highest available general health state, and
if the subset of authenticators includes a plurality of authenticators, select an individual authenticator from the sub-set of authenticators in a round robin fashion.

25. The base station of claim 14 wherein the set of load balancing parameters includes a load component and a general health state component; and
wherein the controller is configured to:
select an authenticator from a sub-set of authenticators having the highest available general health state, and
if the subset of authenticators includes a plurality of authenticators, select an individual authenticator from the sub-set of authenticators using the load component.

26. The base station of claim 14 wherein the transceiver is configured to:
receiving a message indicating the state of an impaired authenticator, wherein the message is transmitted from a device other than the impaired authenticator.
